(19) United States
(12) Patent Application Publication
(10) Pub. No.: US 2008/0183636 A1
(43) Pub. Date: Jul. 31, 2008

(54) METHODS AND SYSTEMS FOR CUSTOMIZING AMOUNTS AND DURATION OF PAYMENTS OF LIFE INSURANCE PRODUCT

(76) Inventors: John T. Walsh, Fair Lawn, NJ (US); Youri Matiounine, White Plains, NY (US); Joseph L. Berkowitz, Riverdale, NY (US)

Correspondence Address: DREIER LLP, 499 PARK AVE, NEW YORK, NY, 10022, US

(21) Appl. No.: 11/668,359

(22) Filed: Jan. 29, 2007

(51) Int. Cl. G06Q 40/00

(52) U.S. Cl. 705/36 R; 705/4

(57) ABSTRACT

An income protection insurance product provides for payment of future benefits that can be customized by amount and/or duration. The benefits are customizable to financially plan for fluctuations in the anticipated expenses of a designated beneficiary that can be attributed to future events, income needs, or the like. The customized benefits are distributed to the designated beneficiary after the death of an insured and/or the occurrence of a secondary triggering event, such as a specified date, admission to an educational institution, age of a designated individual, a major health crisis for a designated individual, or the like. The benefit payments may vary yearly, monthly, or the like. The term can be specified for any duration, such as the lifetime of the designated unchangeable benefit life or a minimum or maximum term. The acquisition cost can be based on a risk profile of the designated unchangeable or changeable benefit life or benefit entity and/or the insured.

### CROSS-REFERENCE TO RELATED APPLICATIONS

The present application is related to a commonly owned, co-pending patent application entitled METHOD AND SYSTEM FOR PROVIDING FLEXIBLE INCOME, LIQUIDITY OPTIONS AND PERMANENT LEGACY BENEFITS FOR ANNUITIES, filed ______, attorney docket No. 3689/28CIP, which is hereby incorporated by reference in its entirety.

### COPYRIGHT NOTICE

A portion of the disclosure of this patent document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

This invention relates to the field of financial planning and insurance, and more particularly to methods and systems for providing life insurance having customizable income, or payout, streams.

### BACKGROUND OF THE INVENTION

With the dawn of the information-processing age and development of global computer networks, people have been seeking increasingly more creative and helpful solutions for improving their quality of life. Health, entertainment, traveling, and finances have historically been the focus of well-informed individuals. The information-age, nonetheless, has provided additional tools and resources to assist such individuals with their endeavors. Even with such resources, the most informed individual might find it difficult to uncover the appropriate resource that can be effectively deployed to provide a specific solution. Consider finances for instance. Being associated with a substantial supply of available financial products and complicated statutes and regulations, financial planning can be a time-intensive and significantly stressful endeavor, especially when a person is planning for major life events, such as major purchases, retirement, or the death of a significant income provider.

A person may invest directly in a bank savings account, stocks, bonds, or other investments as one possible tool for financial planning. However, the average person may not have the time to learn the complicated rules and laws applicable to the different types of investment vehicles. Without the assistance of a competent financial advisor, the person/investor may actually lose more money than is accumulated.

In addition, or alternatively, to the above investments, another possible tool is the purchase of insurance, which provides economic protection against losses that may be incurred due to a random event, such as death, illness, or an accident. There are several forms of insurance, such as life insurance, health insurance, disability insurance, or long-term care insurance. Under life insurance, for instance, an insurance company agrees to pay a specific amount (e.g., face value) to a designated beneficiary on the death of a specified individual (e.g., the insured) in consideration for premium payments received from the purchaser (e.g., the owner or the acquiring party) of the insurance policy.

There are many types of life insurance, but the most common types include term, ordinary, and universal life insurance. Under a term life insurance policy, the term of the policy is set for a defined period, such as one year. If the insured dies during the term of the policy, the designated beneficiary receives a death benefit generally equal to the face value of the policy. If the policy expires prior to the death of the insured, no benefit is due. The premium for life insurance policies is generally based on mortality and/or morbidity rates and therefore increases with the age of the insured.

Unlike term insurance, a whole life insurance includes a savings component in addition to the mortality gain or loss component. A portion of the policy premiums is invested with the anticipation of producing savings. The savings are used to build cash value for the policy that can be redeemed, borrowed against, or used to purchase other investment vehicles.

Universal life insurance has the potential of providing a greater savings component than whole life insurance. Universal life affords the policyholder with the flexibility to modify the policy terms, including the premium payments and amount of coverage. As a result, the amount and frequency of premium payments may increase or decrease over the term of the policy. Being able to change the premium amount and frequency provides the policyholder with the capability of potentially increasing the associated cash value. The potential greater savings associated with universal life insurance are available for loans and other investments. However, the accumulated interest may be taxable upon surrender of the policy.

A common limitation of currently available life insurance policies is that they typically pay a lump sum, and the beneficiary must be able to effectively manage the large sum of money. The lump sum can be applied to address immediate expense needs and to pay off debts, but the beneficiary may not spend the sum wisely. In fact, the lump sum may be exhausted within a short time period, leaving the beneficiary without any significant source of income. Depending on the type of coverage, the exact amount of the lump sum may not be known until the death of the insured. Consequently, the beneficiary may not be able to accurately or sufficiently plan for future income needs.

To overcome the above problems and others, a cost-effective financial planning method and system are needed to assist parties with budgeting and protecting future income.

### SUMMARY OF THE INVENTION

Income protection methods and systems are described herein to enable a party to acquire an income protection insurance product that provides for the payment of an income stream of future benefits that can be customized by amount and/or duration. The income, or payout, stream is customizable to financially plan for fluctuations in the anticipated expenses of a designated beneficiary that can be attributed to future events, income needs, debt repayment, or the like. The designated beneficiary can be the acquiring party of the insurance product, a benefit life for the insurance product where a triggering event is other than the death of a benefit life, or another party.

As described herein, the present invention relates to methods, systems and computer program products for providing income protection insurance for a stream of future benefit payments to designated beneficiaries. Embodiments of the invention include receiving benefit information including a schedule for providing a plurality of benefits, computing a cost to a party acquiring the income protection insurance for providing the plurality of benefits, detecting one or more triggering events that determine a start date for distributing a first benefit of the plurality of benefits, wherein at least one of the one or more triggering events is a death, distributing at least a portion of the first benefit, detecting one or more triggering events that determines a start date for distributing a second or more benefits of the plurality of benefits, and distributing at least a portion of the second or more benefits. The first and second or more benefits could be one or more benefits of a different or the same nature, or one or more benefits of a different or the same amount. The benefits are, in some embodiments, single lump sum payments and in other embodiments comprise a stream of payments over a period of time. The amount of the benefits may be fixed, or may be variable, such as adjusted based on a specified interest rate.

Some embodiments of the invention include receiving benefit duration information specifying a time period for distributing the first benefit and the second or more benefits. In the same or other embodiments, benefit information is received from the party acquiring the income protection insurance or from another entity or source.

In some embodiments of the invention, one or more risk factors associated with at least one of a designated individual and a designated unchangeable benefit life are evaluated. Risk factors may include probabilities of mortality and survival.

In some embodiments of the invention, the triggering events are specific dates, the age of a designated unchangeable benefit life or a designated beneficiary. Triggering events may also include a health condition or status at an educational institution.

In some embodiments, the stream of future benefit payments may be included as a component of an insurance policy or annuity investment product.

In still further embodiments of the present invention, a life insurance product is provided which includes a flexible income feature whereby information useful for issuing a life insurance product providing for a first income payment during a first time period and a second income payment during a second time period following the first time period is received, a cost to a party acquiring the life insurance product to provide the first and second income payments is computed, at least a portion of the computed cost is received and the life insurance product is issued.

In another embodiment of the present invention, a life insurance product is provided which includes a flexible income, or benefit payout, feature and includes receiving information useful for issuing a life insurance product, the information including a first level of benefit payments, a second level of benefit payments, and at least one benefit payout change date, computing a premium or charge necessary to provide the first level of benefit payments before the occurrence of the benefit payout change date and the second level of benefit payments after the occurrence of the benefit payout change date, receiving the computed premium, and issuing a life insurance product providing for the first level of benefit payments before the occurrence of the benefit payout change date and the second level of benefit payments after the occurrence of the benefit payout change date.

Other embodiments of the present invention are also described including providing a stream of future benefit payments to a designated beneficiary, receiving benefit amount information specifying a schedule for distributing a series of benefit amounts, wherein at least one benefit amount specified in the schedule differs from a second benefit amount specified in the schedule, computing a premium or charge for providing the series of benefit amounts, distributing at least one in the series of benefit amounts when the death of a designated individual is determined to have occurred. Probabilities of mortality and survivorship may be measured in computing the premium or charge, including calculating probabilities of mortality and survivorship for the designated individual or for a designated unchangeable benefit life.

As described herein, the income protection insurance product allows the acquiring party, such as the insured, to specify a customized periodic or monthly benefit payment schedule for the payment of future benefits to one or more beneficiaries, which become due upon the death of the insured. Although the death of the insured determines when the benefits become due, it should be understood that in other embodiments, a secondary triggering event can be specified as a condition for determining when a portion, or all, of the benefit payments become due. For example, the secondary triggering event can be a specified date, whereupon a payment schedule can be designed to commence distributions of the benefits on the specified date. In another example, the secondary triggering event can be the death of a designated individual (other than the insured), birth of a child, admission or graduation at an educational institution, age of any designated individual, a major health crisis for any designated individual, or the like.

In some embodiments, the income protection insurance product enables an acquiring party to know precisely how much income will be received at any given point in time or upon occurrence of a predetermined event following the death of the insured. In an embodiment, the periodic or monthly benefit schedule is established at the time the insurance product is issued to the acquiring party or policyholder. In one embodiment, once the benefit schedule is established, the amount and duration specified within the benefit payment schedule is restricted. For example, the amount, duration, or both can be decreased, but not increased. In other embodiments, benefit schedule features may be adjusted upwards or may be fixed. The income protection insurance product can be customized to vary the benefit payments received by the designated beneficiary in accordance with a specified term, such as year-by-year, month-by-month, or the like. The benefit payments can vary in response to the occurrence of specific future events, such changes in inflation, educational expenses, marriage, mortgage payments, or the like.

The income protection insurance product in some embodiments is customized to allow the acquiring party to specify the duration of the benefit payment schedule. For example, the periodic or monthly benefit schedule can be for any duration up to the lifetime of a designated benefit life or benefit entity. As such, the income protection insurance product provides cost-effective lifetime income, or payout, protection to the designated beneficiary for the life of the benefit life. Alternatively, the benefit schedule can be established to last for a stated minimum and/or maximum period of time that is not based on the lifetime of a designated unchangeable benefit life.

The acquisition cost (or premium payments) for the income protection insurance product can be calculated based on the risk profile of the insured and/or benefit life, or benefit entity. For example, if an insured acquires the insurance product for a designated beneficiary and the designated beneficiary is also the benefit life, the acquisition cost can be calculated based on the risk profile of the insured and/or benefit life. The risk profile may reflect items such as age, sex, and risk class of the benefit life, as appropriate.

In an embodiment, the acquisition cost is based on the risk profiles of the insured life and the benefit life. If an insured acquires the insurance product for a designated beneficiary, the acquisition cost is based on the risk profiles of the insured and the designated beneficiary, if that beneficiary is also designated as the unchangeable benefit life. If an insured acquires the insurance product for a designated beneficiary, and the insurance product provides survivorship rights to a contingent beneficiary, the acquisition cost is based on the risk profiles of the insured, the designated beneficiary, and the contingent beneficiary if the contingent beneficiary is designated as the unchangeable benefit life. Since the acquisition cost is based on multiple contingent events, and payment is not in a lump sum, the acquisition cost for the income protection insurance product should be lower than the cost for products based on one contingent event as well as solely lump sum payment products.

The income protection insurance product can be issued as a standalone policy. Alternatively, the income protection insurance product can be included in one or more riders to any life insurance product, such as term or universal life and including an income protector product. If included as a rider to a life insurance product, the payment of a lump sum can be provided from the life insurance policy, and periodic or monthly benefits can be provided from an income protection rider to the designated beneficiary in accordance with a periodic or monthly benefit schedule specified in the income protection rider.

In one embodiment, an unchangeable benefit life is required to be designated to determine if the beneficiary will receive the periodic or monthly benefits when a lifetime schedule is specified, and the benefit payments are contingent upon the survival of the unchangeable benefit life. When a lifetime schedule is requested, the age and sex of the unchangeable benefit life, in addition to other information, is applied to determine the acquisition cost for the income protection insurance product.

In another aspect of the invention, the duration of the income protection insurance product is set to a minimum and/or maximum period that is not based on the lifetime of an unchangeable benefit life. In this aspect, a beneficiary, contingent or otherwise, can be specified to receive the periodic or monthly benefits if a primary beneficiary dies before the acquisition cost is paid in its entirety. When the primary beneficiary becomes eligible to receive the benefit payments, the terms of the insurance product may be written to enable the primary beneficiary to designate a contingent beneficiary to receive any benefit payments due after the death of the primary beneficiary.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a method for providing an income protection insurance product according to an embodiment of the present invention;

FIG. 2A illustrates a method for financing or underwriting an income protection insurance product according to an embodiment of the present invention;

FIG. 2B illustrates a method for financing or underwriting an income protection insurance product according to an embodiment of the present invention; and

FIG. 3 illustrates a system for providing and underwriting an income protection insurance product according to an embodiment of the present invention.

### DETAILED DESCRIPTION OF THE PREFERRED EMBODIMENTS

The methods and systems according to the present invention may be applied to any type of insurance product, such as a long-term care policy, or an annuity. Therefore, although the methods and systems herein will be discussed by way of example in relation to life insurance, it is understood that the present invention is not limited thereto. Income protection methods and systems are described herein to enable a party to acquire an income protection insurance product that provides for the payment of an income stream of future benefits, which can be customized by amount and/or duration. The income stream is customizable to plan for fluctuations in the anticipated expenses of a designated beneficiary that can be attributed to future events, income needs, debt repayment, or the like. The designated beneficiary can be the acquiring party of the insurance product, a benefit life for the insurance product, or another party. In some embodiments, an entity whose attributes determine the premiums, fees or charges and/or face value of the insurance product, or whose attributes determine the occurrence of a triggering event, may be designated and may be referred to as a benefit life or benefit entity. The income protection insurance product can be modified to include survival rights, such that a contingent beneficiary can be designated in the event that the primary beneficiary dies before the benefits are fully paid.

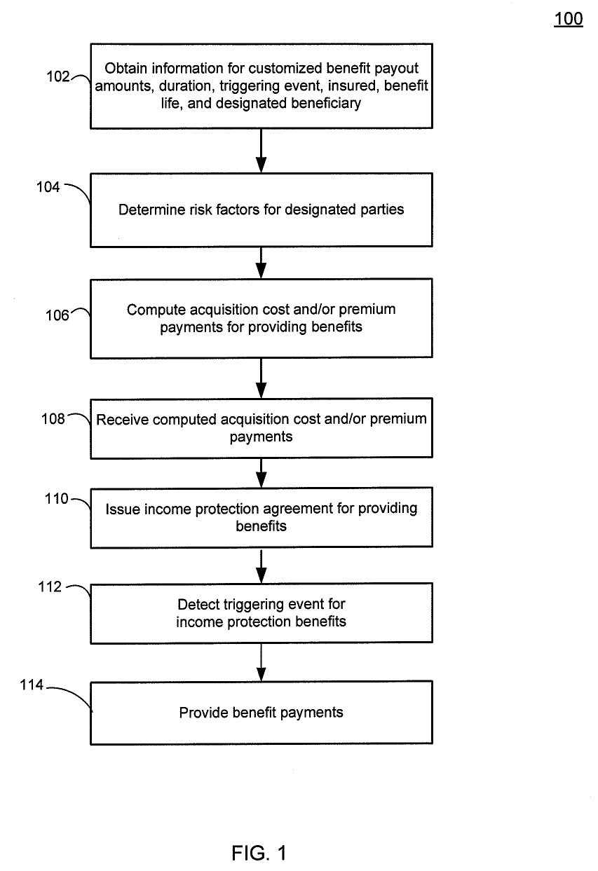

Referring to FIG. 1, flowchart 100 illustrates a method for providing an income protection insurance product that is customizable to distribute a stream of future benefits to a designated beneficiary, which can include the acquiring party, the benefit life, or another party. The method of flowchart 100 may be implemented, for example, with system 300 described herein.

At 102, information specifying an insured, a designated beneficiary, one or more triggering events, and future income needs of at least one designated beneficiary are collected, so that a customized periodic or monthly benefit payment schedule can be established for an income protection insurance product. The benefit payment schedule allows the acquiring party to specify the payment amounts for the future benefits, which become due upon the death of the insured.

As described in this embodiment, the death of an insured is the triggering event that determines when the benefits become due. However, it should be understood that in other embodiments, a secondary triggering event can be specified as a condition for determining when a portion, or all, of the benefit payments become due. For example, the secondary triggering event can be a specified date, whereupon a benefit payment schedule can be designed to commence distributions of a portion or all of the benefits on the specified date. In another example, the secondary triggering event can be the death of a designated individual (other than the insured), birth of a child, admission or graduation at an educational institution, age of any designated individual, a major health crisis for any designated individual, or the like.

The income protection insurance product enables the acquiring party to specify precisely how much income will be distributed at any given point in time or upon occurrence of a predetermined event following the death of the insured. In an embodiment, the periodic or monthly benefit schedule is established at the time the insurance product is issued to the acquiring party or policyholder. In this embodiment, once the benefit schedule is established, the amount and duration specified within the benefit payment schedule is restricted. For example, the amount, duration, or both can be decreased but not increased. In other embodiments, the schedule is not restricted and schedule aspects are adjusted upwards or remain fixed.

In some embodiments, a great deal of flexibility is built into the benefit payment schedule. The income protection insurance product can be customized to vary the benefit payments received by the designated beneficiary in accordance with a specified term, such as year-by-year, month-by-month, or the like. The benefit payments can vary in response to specific future events. For example, the benefits can increase to adjust for inflation, cost of living, or the like. The benefit payments may balloon during specific occasions to cover educational expenses, marriage, or the like. The benefits payments may be stipulated to decrease upon the occurrence of specific events, such as following the payoff of a mortgage, children reaching an age of maturity, or the like.

In some embodiments, the income protection insurance product is customized to vary the duration and/or benefit payment amounts of the benefit payment schedule, which duration or benefit payment amounts may be specified by the acquiring party. For example, the periodic or monthly benefit schedule can be for any duration up to the lifetime of a designated unchangeable benefit life. As such, the income protection insurance product provides cost-effective lifetime income protection to the designated beneficiary for the life of the benefit life. Alternatively, the benefit schedule can be established to last for a stated minimum and/or maximum period of time that is not based on the lifetime of a designated unchangeable benefit life.

In an embodiment, the benefit payment schedule can be customized to distribute payments to multiple beneficiaries. For example, a first beneficiary can be designated to receive benefits for a first time period that is specified in the benefit payment schedule; a second beneficiary can be designated to receive benefits for a second specified time period; and a third beneficiary can be designated to receive benefits for the life of the third beneficiary. In this example, the time periods are structured to occur sequentially, without any overlapping and with the third beneficiary being an unchangeable benefit life. Many other embodiments are possible. For instance, one or more of the time periods may occur concurrently with another, payment periods can be contingent on triggers other than time, multiple beneficiaries may be designated with different triggering contingencies or time periods, or any combination thereof or other variations. In embodiments providing benefit payments to a plurality of beneficiaries concurrently or sequentially, a plurality of benefit lives can be used to determine the premium payments or charges and/or face value or Income Protection Imputed Benefit Value of the resulting income protection insurance product.

The benefit life may be changed in some embodiments. Further still, in some examples, the income protection insurance product includes a provision that allows a designated beneficiary to be changed during the premium payment period or following the death of the insured. If the change in beneficiary affects the benefit life, the premiums can be re-computed to account for any price adjustments at the time of conversion.

At 104, at least one risk factor for the income protection insurance product is determined based at least in part on the information collected at 102. In one embodiment, risk factors include mortality and morbidity rates for the insured and/or the benefit life. The risk factor is applied at step 106 to compute the acquisition cost (and/or premium payments) for the income protection insurance product. The acquisition cost (and/or premium payments) can be based on a risk class or profile determined for the insured and/or the benefit life based one or more risk factors. In one embodiment, the risk profile reflects the age and sex of the insured and/or benefit life. In other embodiments, the risk profile reflects variables such as age, sex, health condition, health history, smoker status, or other risk factors corresponding to the insured and/or benefit life.

In an embodiment, the acquisition cost is based on the risk profiles of two parties. It should be understood that if a triggering event is an event other than the death of a benefit entity, the benefit entity could also be a designated beneficiary. If an insured acquires the insurance product for a designated beneficiary, the acquisition cost is based on the risk profiles of the insured and the designated beneficiary, if that beneficiary is the benefit entity in an embodiment. If an insured acquires the insurance product for a designated beneficiary, and the insurance product provides survivorship rights to a contingent beneficiary, the acquisition cost can be based on the risk profiles of the insured, the designated beneficiary, and the contingent beneficiary if the contingent beneficiary and the designated beneficiary are designated unchangeable benefit entities.

In an embodiment, a beneficiary is required to be designated to receive the periodic or monthly benefits when a lifetime schedule is specified, and the benefit payments are contingent upon the survival of the unchangeable benefit life. When a lifetime schedule is requested, the age and sex of the unchangeable benefit life, in addition to other information, is applied to determine the acquisition cost for the income protection insurance product.

A contingent beneficiary can be specified to receive the benefits if the primary beneficiary dies before the acquisition cost is paid in its entirety. In some embodiments, once the primary beneficiary becomes eligible to receive the benefit payments, the insurance product allows the primary beneficiary to designate a contingent beneficiary to receive any benefit payments due after the death of the primary beneficiary.

If the duration or characteristics of the payments under the income protection insurance product is based on the lifetime of an unchangeable benefit life, the benefit payments cease upon the death of the unchangeable benefit life, unless otherwise modified by the terms of the income protection insurance product.

In an embodiment, age restrictions are placed on eligibility requirements for the insured life. For example, the income protection insurance product can be limited to individuals having ages ranging from eighteen to ninety; age restrictions for the unchangeable benefit life can be limited to individuals having ages ranging from forty to ninety. However, it should be understood that other age ranges can be used as determined by the authority designing the income protection insurance product.

The income protection insurance product can be backdated to start coverage of the benefit payments prior to the execution of the insurance product, or future dated to commence coverage at a future date. If backdating is implemented, the coverage start date can be limited to a specific period, such as one month prior to the application date. If future dating is implemented, the coverage start date can also be limited to a specific period, such as one month following the application date. Re-dating the start of coverage can also be allowed. If re-dating (including backdating and future dating) is implemented, the acquisition cost (and/or premium payments) is recalculated if the age of the acquiring party and/or designated unchangeable benefit life changes as a result of the date changes.

In one embodiment, the acquisition cost determined at 106 is computed by a benefit provider, for example, an insurance company, which distributes the benefit payments. Such computations may include, for example, estimating the cost of providing the desired level of benefits or calculating the present value of the benefits. In computing the acquisition cost, the benefit provider may also use any suitable actuarial data, for example, any suitable mortality or morbidity tables, and any suitable statistical data relating to longevity of the insured and/or benefit life. Alternatively, or in addition, the benefit provider may utilize any suitable statistical or Monte Carlo analyses to estimate future investment returns, interest rates, inflation factors, cost of living factors, or the like.

In some embodiments, the acquisition cost is computed to account for the cost of funding the income protection insurance product and to provide for an accumulation of value (e.g., cash value) in the income protection insurance product. The accumulation of value includes the paid premiums, including additional cash value buildup due to the investment gains on the paid premiums. Therefore, the income protection insurance product may have cash value depending on the type of coverage elected, as described in greater detail below.

An exemplary formula suitable for computing present value factors for the acquisition cost (and/or premium) is as follows:

$${PV}_{t} = {\prod }_{k = 1}^{t} \frac{1}{1 + {i}_{k}} = present value factor for a \$1 certain payment in year t$$

$${PV}_{y , t} = {\prod }_{k = 1}^{t} \frac{1 - {q}_{y + k}}{1 + {i}_{k}} = present value factor for a \$1 life contingent payment in year t$$

where:
y=age of a party on whose life the payments are contingent
iₖ=discount interest rate for coverage in year k
q_{y+k}=expected mortality of the annuitant in year k.
At 108, the benefit provider receives at least a portion of the computed acquisition cost. The acquisition cost can be paid in a single sum or financed over time as a premium (e.g., paid periodically on a weekly, bi-weekly, monthly, or annual basis, or the like). The acquisition cost or premium payments can be flexible or fixed, guaranteed or non-guaranteed, and/or level or non-level. If premiums are calculated on a fixed premium basis, the premiums can be paid in a single sum, on a limited level payment schedule, or on a level pay basis. Limited premium payment schedules may be desirable to the financier or underwriter of the income protection insurance product because the value of the benefit payments diminishes over time. If on the other hand the premiums are flexible and indeterminate, the premiums can be paid on any basis so long as the income protection insurance product remains valid and enforceable.

In some embodiments, the cost for the income protection product is charged to an account corresponding to the party acquiring the product, which account includes amounts paid to the product provider by the acquiring party and may include interest gains. The product provider deducts or withdraws charges for the product from the account according to the product terms. In some embodiments, such as one in which a universal life insurance product structure is utilized, a provider calculates the present value of the stream of payments for the income protection products and specifies that present value as the face amount of the product. The present value may be calculated based on the assessment of specified contingencies. Charges to the account of the acquiring party are based on the determined Income Protection Imputed Benefit Value (IPIBV), as described herein.

At 110, the provider specifies the terms of the income protection insurance product, which may be relayed to the acquiring party in any number of ways, including through a document (e.g.,. income protection agreement) or electronically. For example, the document may be issued as a paper document or may be a paperless computer record in a benefit provider's database.

At 112, the specified triggering event specified at 102, is detected. The benefit provider provides at 114 the benefit payment to the designated beneficiary as specified in the benefit payment schedule. Upon distribution of the benefit payment, the control flow of flowchart 100 ends. The payment terms may vary. In some embodiments, the payments may have a specified end date, and in others the payments are determined based on the outcome of factors (such as an interest rate) which may result in payments that fluctuate in amount and/or term. Other variations are possible and contemplated by the present invention.

As discussed with reference to 114, in some embodiments, benefit payments are remitted to the designated individual in accordance with a customized benefit payment schedule. In an embodiment, a designated beneficiary can opt, at the time of distribution, to receive less than the specified amount. The non-distributed portions of an amount due can be allocated among future payments. Therefore, the designated beneficiary may defer receipt of all or a portion of the benefit payments.

The income protection insurance product can be issued as a standalone policy. Alternatively, the income protection insurance product can be included in one or more riders to any life insurance product, including an income protector product. If included as a rider to a life insurance product, the payment of a lump sum can be provided from the life insurance product, and periodic or monthly benefits can be provided from the income protection rider to the designated beneficiary in accordance with a periodic or monthly benefit schedule specified in the income protection rider. In other words, when the insured dies, a lump sum amount specified on the life insurance product is paid to the designated beneficiary to, for example, help with immediate expenses and/or to pay off debts associated with mortgages, credit cards, or the like. The periodic or monthly benefits provided by the income protection rider is paid to the designated beneficiary in accordance with the benefit schedule, for example, to accommodate for a loss of income and/or future expenses.

If the income protection insurance is provided as a rider, a monthly rider charge can be computed as a product of a rider cost-of-insurance protection (COI) rate and a rider Income Protection Imputed Benefit Value (IPIBV). An exemplary formula suitable for computing the rider COI rate and rider IPIBV is as follows:

$${COI}_{x + t} = {q}_{x + t} \cdot {F}_{t} = rider COI rate in year t , where {F}_{t} is loading factor in year t . \\ {IPIBV}_{t} = {\sum }_{k = t}^{ω - x} {B}_{k} \cdot \frac{{PV}_{k}^{*}}{{PV}_{t}^{*}} = imputed benefit value of the rider ,$$

where

Bₜ is rider benefit in year t,

PVₜ* is PVₜ for payments that are not life contingent, and it is PV_{y,t} for life contingent payments.

x=issue age of a party of interest

y=issue age of a designated unchangeable benefit life (used only for life contingent payments)

t=coverage duration, where t=1,2,3, . . . , ω−x

ω=ultimate age in mortality table (121 for 2001 CSO)

In some embodiments, the rider for income protection insurance may have a cash surrender value associated with it.

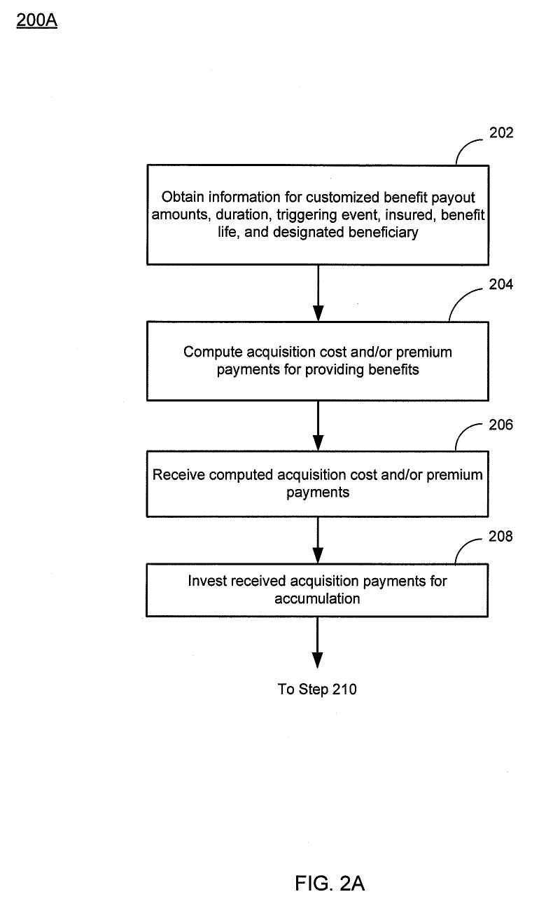

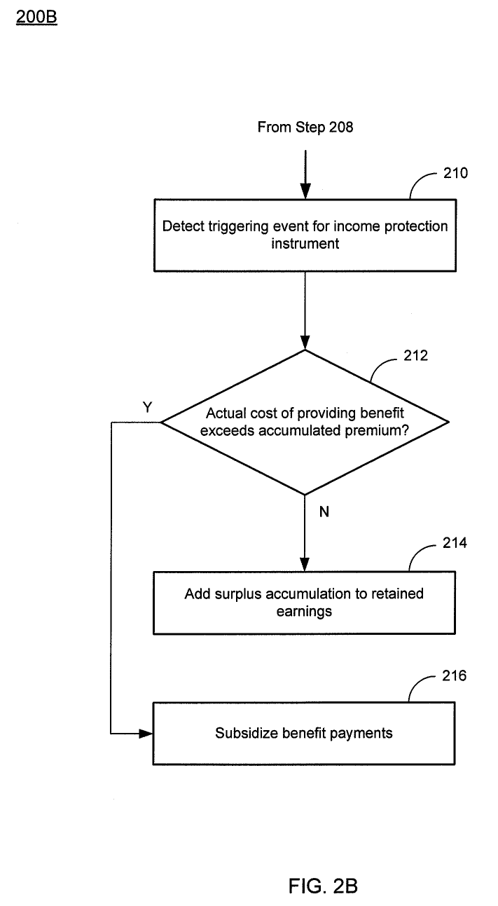

Referring to FIGS. 2A and 2B, flowchart 200 (shown as flowcharts 200A and 200B) illustrates a method for financing or underwriting an income protection insurance product. Underwriting requirements are determined and based on the net present value of the benefit payment schedule. The underwriting is implemented so that an agent or seller will know the underwriting requirements at the time the application for the income protection instrument is completed.

In an embodiment, at 202 information specifying a designated beneficiary, a benefit life (if applicable), triggering events, and a customized periodic or monthly benefit payment schedule are received by the financing entity or underwriter of the income protection insurance product. Information regarding a benefit life may also be received in some embodiments. For example, the underwriter of the benefits may be an insurance company. The type and content of the information received at step 202 generally corresponds to the information obtained at step 102, described above.

At 204, the benefit provider computes the acquisition cost (and/or premium payments) required to provide the payment benefits. The computation of acquisition cost at 204 is generally comparable to the acquisition cost computations at 106 of flowchart 100, described above.

At 206, the provider receives at least a portion of the computed acquisition cost. The receiving of the computed acquisition cost at 206 is generally comparable to the receiving of the computed acquisition cost at step 108 of flowchart 100, described above. At 208, the provider invests all or a portion of the received acquisition cost for accumulation. Various suitable investment vehicles may be used for investing the received premiums, as known to those of skill in the relevant art(s). The provider may use any suitable market performance data to account for investment gains and/or losses.

At 210, the specified triggering event, specified at 202, is detected. At 212, the benefit provider checks whether the actual cost of providing the income protection insurance product exceeds the acquisition cost (or premium payments) accumulated at 208. If the actual cost of providing the income protection insurance product exceeds the accumulated acquisition cost, it may result in a loss for the benefit provider, which may need to subsidize the cost of providing the income protection insurance product at 216. If the actual cost of providing the income protection insurance product is less than the accumulated acquisition cost, the benefit provider may add the surplus accumulation to its retained earnings at 214 and use it, for example, to offset the cases in which the benefit payments due for income protection insurance policies exceed the corresponding accumulated acquisition costs. As those skilled in the relevant art(s) will appreciate, by creating a large pool of benefit participants, the benefit provider may be able to offset the instances in which the benefit payments due for income protection insurance policies exceed the corresponding accumulated acquisition costs with the instances in which the actual cost of providing the benefit payments due for income protection insurance policies are less than the corresponding accumulated acquisition costs.

In one embodiment, provisions for forfeiting a portion or all of the benefit payments due for the income protection insurance product are provided. If an indeterminate premium structure is used, the income protection insurance product remains in force as long as the cash surrender value (e.g., the accumulated acquisition cost) is sufficient to cover the deduction expenses for the periodic or monthly benefit payments. When the cash surrender value is not sufficient to cover the deduction expenses, a lapse notification can be sent to the acquiring party for the premium due to keep the income protection insurance product in force for a specified period of time (e.g., at least two months). Additionally, a grace period of a specified period of time (e.g., 31 days) can be allowed. If the premium is not paid by the end of the grace period, the income protection insurance product would lapse and all coverage would end.

If a fixed premium structure is used and if the premiums are not paid within a specified period of time (e.g., one month) after their due date, a lapse notification can be sent to the acquiring party for the amount due as calculated from the premium payment interval specified in the income protection insurance product. A grace period can be allowed from the due date of premium in arrears. If the premium is not paid by the end of the grace period, the income protection insurance product would lapse and all coverage would end. The cash value, if available, can be paid to the acquiring party at that time, unless other contractual or statutory requirements apply. The cash value can be available for full surrender, or partial surrender if the acquiring party has taken loans against the case value. If outstanding loans exist, the cash value is applied to repay the loans, and the remaining amount can be surrendered.

In some embodiments, if an unchangeable benefit life is designated and the unchangeable benefit life predeceases the acquiring party, the income protection insurance coverage would lapse and all income protection coverage would end. The cash value of the product, if available, could be paid to the acquiring party as a termination benefit or could be used to continue the base policy of insurance if this coverage was provided in the form of a rider attached to a base plan policy. In another embodiment, the benefit could succeed to another beneficiary. In these or other embodiments, the benefit may continue for a fixed number of years, or may continue for a fixed number of years plus for so long as the beneficiary is alive. Other variations are possible consistent with the scope of the invention.

Other non-forfeiture benefits can be provided as required by federal, state, or local laws and regulations. For example, a state may require standard reversionary annuity provisions that address reinstatement and the reduction of annuity benefits for overdue payments.

In an embodiment, a Payment Certain Benefit Period is provided as an option for the income protection insurance product. The option guarantees that the total period of benefit payments distributed under the terms of the insurance product will be at least equal to the period specified as a Payment Certain Period in the terms of the income protection insurance product. If the benefit life dies before the end of a Payment Certain Period, benefit payments will continue to a designated beneficiary (e.g., the primary beneficiary or a contingent beneficiary), according to the terms of the benefit payment schedule until the Payment Certain Period has ended. The option can be provided for an additional fee. If implemented, the option can be applied in circumstances that specify a lifetime benefit schedule and an unchangeable benefit life.

In an example using fixed period schedules, a five-year minimum benefit guarantee can be provided. The guarantee ensures that at least five years of benefits are paid if the insured dies while the income protection coverage is in effect. This holds true even if there are less than five years remaining on the fixed period benefit schedule.

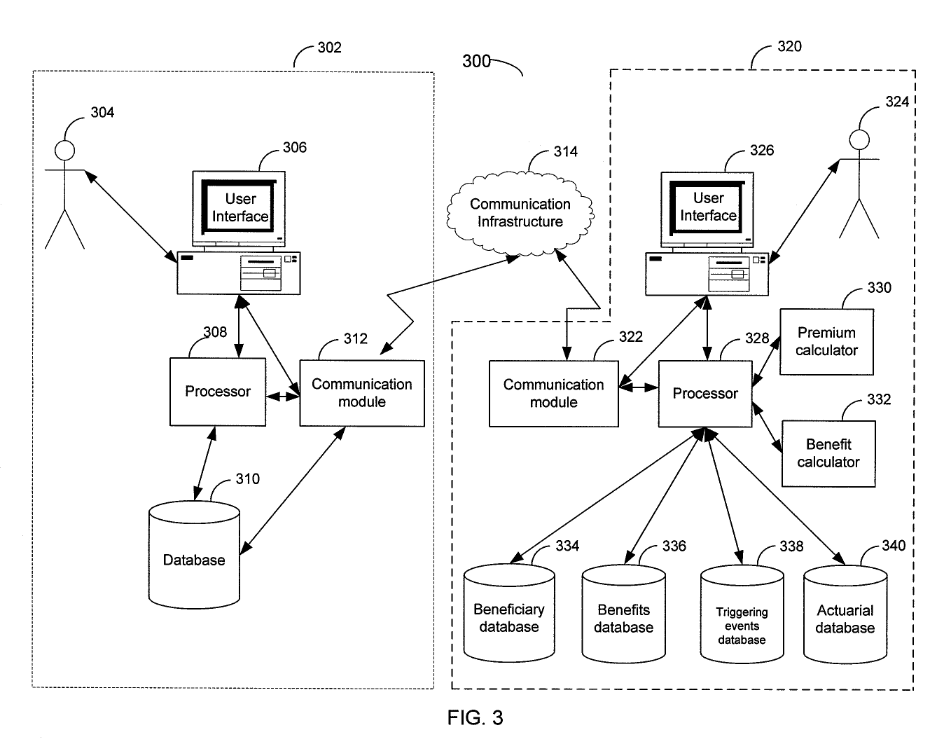

Referring to FIG. 3, there is shown a system 300 for providing and underwriting an income protection insurance product according to an embodiment of the present invention. System 300 may be suitable in implementing flowcharts 100 and 200, described in detail above.

System 300 includes a client 302 and a server 320. Client 302 includes a user interface 306 for obtaining information from a user 304 to determine a payment benefit, benefits beneficiaries, and benefits triggering events. User interface 306 is connected to a processor 308 and a communication module 312. Processor 308 is connected to a database 310, which may also be connected to communication module 312. Database 310 may be used for storing the information regarding the insured, the benefits, benefits beneficiaries, and benefits triggering events. Client 302 communicates with server 320 via communication infrastructure 314.

Communication infrastructure 314 provides a transmission medium for communicating among the system components. Communication infrastructure 314 includes a wired and/or wireless local area network (LAN), wide area network (WAN), or metropolitan area network (MAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communication infrastructure 314 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

Server 320 may include a communication module 322 for communicating with client 304 and receiving the information for determining the benefits, benefits beneficiaries, conversion events, and benefits triggering events. It may further include a user interface 326 to enable a benefit administrator 324 to administer the benefits in accordance with the processes described herein. Server 320 may also include a processor 328 connected to a premium calculator 330, a benefit calculator 332, a beneficiary database 334, a benefits database 336, a triggering events database 338, and an actuarial database 340.

FIGS. 1-3 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms machine readable medium, computer program medium, and computer usable medium are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment. Other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, it is not intended for any term in the specification or claims to be ascribed an uncommon or special meaning unless explicitly set forth as such. Further, the present invention encompasses present and future known equivalents to the known components referred to herein by way of illustration.

While the invention has been described and illustrated in connection with various embodiments, many variations and modifications as to be evident to those of skill in the relevant art(s) may be made without departing from the spirit and scope of the invention, and the invention is thus not to be limited to the precise details of methodology or construction set forth above, as such variations and modifications are intended to be included within the scope of the invention. It is to be understood by those of ordinary skill in the relevant art(s) that the various data processing tasks described herein may be implemented in a wide variety of ways, many of which are known and many more of which are doubtless to be hereafter developed. For example, a wide variety of computer programs and languages are now known, and are likely to be developed, which are suitable for storing, accessing, and processing data, as well as for performing, processing, and using actuarial forecasts and other analyses as disclosed herein. Except to the extent necessary or inherent in the processes themselves, no particular order to steps or stages of methods or processes described in this disclosure, including the figures, is implied. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Thus, the present invention should not be limited by any of the above-described exemplary embodiments, but should be defined only in accordance with the following claims and their equivalents.

What is claimed is:

1. A computerized method for providing an income protection insurance providing for a stream of future benefit payments to a designated beneficiary, the method comprising:
receiving benefit information including a schedule for providing a plurality of benefits;
computing a cost to a party acquiring the income protection insurance for providing the plurality of benefits;
detecting one or more triggering events that determine a start date for distributing a first benefit of the plurality of benefits, wherein at least one of the one or more triggering events is a death;
distributing at least a portion of the first benefit;
detecting one or more triggering events that determines a start date for distributing one or more second benefits of the plurality of benefits; and
distributing at least a portion of the one or more second benefits.

2. The method of claim 1, comprising:
receiving benefit duration information specifying a time period for distributing the first benefit and the second benefit.

3. The method of claim 1, wherein receiving comprises: receiving the benefit information from the party acquiring the income protection insurance.

4. The method of claim 1, wherein the first benefit differs from the one or more second benefits.

5. The method of claim 1, wherein computing comprises:
evaluating one or more risk factors associated with at least one of a designated individual and a designated unchangeable benefit life.

6. The method of claim 5, wherein the one or more risk factors comprise probabilities of mortality and survival.

7. The method of claim 5, wherein detecting one or more triggering events comprises detecting the death of the designated individual.

8. The method of claim 1, wherein the one or more triggering events comprises a specific date.

9. The method of claim 1, wherein the one or more triggering events comprises an age of a designated unchangeable benefit life.

10. The method of claim 1, wherein the one or more triggering events comprises an age of a designated beneficiary.

11. The method of claim 1, wherein the one or more triggering events comprises a health condition.

12. The method of claim 1, wherein the one or more triggering events comprises status at an educational institution.

13. The method of claim 1, comprising:
including the stream of future benefit payments as a component of an insurance policy.

14. The method of claim 1, comprising:
including the stream of future benefit payments as a component of an annuity investment product.

15. A computerized method of providing a life insurance product including a flexible payout feature, the method comprising:
receiving information useful for issuing a life insurance product providing for a first income payment during a first time period and a second income payment during a second time period following the first time period;
computing a cost to a party acquiring the life insurance product to provide the first and second income payments;
receiving at least a portion of the computed cost; and
issuing the life insurance product.

16. A computerized method of providing a life insurance product including a flexible payout feature, the method comprising:
receiving information useful for issuing a life insurance product, the information including a first level of income payments, a second level of income payments, and at least one income change date;
computing a premium necessary to provide the first level of income payments before the occurrence of the income change date and the second level of income payments after the occurrence of the income change date;
receiving the computed premium; and
issuing a life insurance product providing for the first level of income payments before the occurrence of the income change date and the second level of income payments after the occurrence of the income change date.

17. A computerized method for providing a stream of future benefit payments to a designated beneficiary, the method comprising:
receiving benefit amount information specifying a schedule for distributing a series of benefit amounts, wherein at least one benefit amount specified in the schedule differs from a second benefit amount specified in the schedule;
computing a premium for providing the series of benefit amounts; and
distributing at least one in the series of benefit amounts when the death of a designated individual is determined to have occurred.

18. The method of claim 17, wherein computing comprises:
using probabilities of mortality and survival for the designated individual.

19. The method of claim 17, wherein computing comprises:
using probabilities of mortality and survival for a designated unchangeable benefit life.

20. A computer program product for use in a computer system that executes program steps recorded on one or more computer readable media to perform a method of providing an income protection insurance providing for a stream of future benefit payments to a designated beneficiary, the computer program product comprising:
one or more computer readable media;
one or more computer programs of computer readable instructions executable by the computer system to perform method steps comprising:
receiving benefit information including a schedule for providing a plurality of benefits;
computing a cost to a party acquiring the income protection insurance for providing the plurality of benefits;
detecting one or more triggering events that determine a start date for distributing a first benefit of the plurality of benefits, wherein at least one of the one or more triggering events is a death;
distributing at least a portion of the first benefit;
detecting one or more triggering events that determines a start date for distributing one or more second benefits of the plurality of benefits; and
distributing at least a portion of the one or more second benefits.

21. The computer program product of claim 20, wherein receiving benefit duration information comprises specifying a time period for distributing the first benefit and the one or more second benefits.

22. The computer program product of claim 20, wherein receiving comprises receiving the benefit information from the party acquiring the income protection insurance.

23. The computer program product of claim 20, wherein the first benefit differs from the one or more second benefits.

24. The computer program product of claim 20, wherein computing comprises evaluating one or more risk factors associated with at least one of a designated individual and a designated unchangeable benefit life.

25. The computer program product of claim 24, wherein the one or more risk factors comprise probabilities of mortality and survival.

26. The computer program product of claim 20, wherein the one or more triggering events comprises a specific date.

27. The computer program product of claim 20, wherein the one or more triggering events comprises an age of a designated unchangeable benefit life

28. The computer program product of claim 20, wherein the one or more triggering events comprises an age of a designated beneficiary.

29. The computer program product of claim 20, wherein the one or more triggering events comprises a health condition.

30. The computer program product of claim 20, wherein the one or more triggering events comprises status at an educational institution.

31. The computer program product of claim 20, wherein the one or more computer programs of computer readable instructions executable by the computer system performs a method step of including the stream of future benefit payments as a component of an insurance policy.

32. The computer program product of claim 20, wherein the one or more computer programs of computer readable instructions executable by the computer system performs a method step of including the stream of future benefit payments as a component of an annuity investment product.

33. A computer program product for use in a computer system that executes program steps recorded on one or more computer readable media to perform a method of providing a life insurance product including a flexible payout feature, the computer program product comprising:
one or more computer readable media;
one or more computer programs of computer readable instructions executable by the computer system to perform method steps comprising:
receiving information useful for issuing a life insurance product providing for a first income payment during a first time period and a second income payment during a second time period following the first time period;
computing a cost to a party acquiring the life insurance product to provide the first and second income payments;
receiving at least a portion of the computed cost; and
issuing the life insurance product.

34. A computer program product for use in a computer system that executes program steps recorded on one or more computer readable media to perform a method of providing a life insurance product including a flexible income feature, the computer program product comprising:
one or more computer readable media;
one or more computer programs of computer readable instructions executable by the computer system to perform method steps comprising:
receiving information useful for issuing a life insurance product, the information including a first level of income payments, a second level of income payments, and at least one income change date;
computing a premium necessary to provide the first level of income payments before the occurrence of the income change date and the second level of income payments after the occurrence of the income change date;
receiving the computed premium; and
issuing a life insurance product providing for the first level of income payments before the occurrence of the income change date and the second level of income payments after the occurrence of the income change date.

35. A computer program product for use in a computer system that executes program steps recorded on one or more computer readable media to perform a method for providing a stream of future benefit payments to a designated beneficiary, the computer program product comprising:
one or more computer readable media;
one or more computer programs of computer readable instructions executable by the computer system to perform method steps comprising:
receiving benefit amount information specifying a schedule for distributing a series of benefit amounts, wherein at least one benefit amount specified in the schedule differs from a second benefit amount specified in the schedule;
computing a premium for providing the series of benefit amounts; and
distributing at least one in the series of benefit amounts when the death of a designated individual is determined to have occurred.

36. The computer program product of claim 35, wherein computing comprises calculating probabilities of mortality and survival of the designated individual.

37. The computer program product of claim 35, wherein computing comprises calculating probabilities of mortality and survival for a designated unchangeable benefit life.
